(19) United States
(12) Patent Application Publication
(10) Pub. No.: US 2012/0082282 A1
(43) Pub. Date: Apr. 5, 2012

(54) METHODS RELATING TO PHOTONUCLEAR DETECTION

(75) Inventors: Daren Reeve Norman, Idaho Falls, ID (US); James Litton Jones, Idaho Falls, ID (US); Kevin James Haskell, Idaho Falls, ID (US); David Walter Gerts, Idaho Falls, ID (US); David Lee Chichester, Idaho Falls, ID (US); Woo Yong Yoon, Idaho Falls, ID (US)

(73) Assignee: BATTELLE ENERGY ALLIANCE, LLC, IDAHO FALLS, ID (US)

(21) Appl. No.: 12/487,543

(22) Filed: Jun. 18, 2009

(51) Int. Cl. G01T 3/00

(52) U.S. Cl. 376/154

(57) ABSTRACT

Methods relating to photonuclear detection are disclosed. A method of operating a photonuclear detection system may include transmitting photons toward a container for a duration of a first time period. The method may further include waiting for a duration of a second time period substantially equal to a detector recovery time of a radiation detector proximate the container. Additionally, the method may include measuring for induced delayed signatures for a duration of a third time period.

### GOVERNMENT RIGHTS

The United States Government has certain rights in this invention pursuant to Contract No. DE-AC07-05-ID14517 between the United States Department of Energy and Battelle Energy Alliance, LLC.

### TECHNICAL FIELD

Embodiments of the present invention relate generally to photonuclear detection and, more specifically, to methods of operating a photonuclear detection system.

### BACKGROUND

With ever-increasing demand for international trade and commerce, it is becoming increasingly difficult for a country to monitor its borders for nuclear materials in order to prevent adverse parties from building and detonating nuclear-type weapons within its borders. Various methods and devices have been proposed for inspecting sealed containers for purposes of identifying nuclear material and other potentially harmful materials that may be used for terrorism or for other unlawful activities. Due to limitations in conventional methods, nuclear materials may go unnoticed by being positioned or otherwise concealed within larger storage containers.

Nondestructive detection techniques of nuclear materials are characterized as passive or active depending on whether they measure radiation from the spontaneous decay of the nuclear material or from the radiation induced by an external interrogating source. Passive techniques can provide some capability in detecting nuclear materials; however, these techniques are limited due to the wide variety of possible nuclear material shielding configurations, the physical positioning within these large cargo containers, and from large standoff distances.

One active interrogation technique, using an external neutron or a high-energy photon source, can be used to detect nuclear materials via neutron multiplication effect from fissioning-events in nuclear materials. As will be appreciated by a person having ordinary skill in the art, delayed neutrons and delayed gamma-rays may be emitted from photofission-induced and neutron fission-induced fission fragments. One conventional mode of active interrogation involves measuring for induced delayed neutrons (i.e., material signatures) between each pulse of an interrogating source. This mode allows for stimulation of the nuclear material to reach a saturation level. As a result, this mode increases the amount of fission fragments produced and, thus increases the amount of delayed neutrons emitted from the nuclear material. Although this mode of operation provides for adequate material stimulation, as opposed to other conventional modes of operation, some radiation detectors may experience difficulty in recovering from the interrogating environment due to interference between the interrogation radiation and the induced delayed neutrons.

Conversely, another conventional mode of active interrogation involves measuring for induced delayed neutrons after an interrogating source has been turned off. Although this mode of operation may decrease the interference between the interrogation radiation and the induced delayed neutrons, a measured signal may be weak due to a limited number of measurement cycles and furthermore, because the strongest signal may be within a few seconds following interrogation.

There is a need to enhance methods of measuring for induced delayed signatures from pulsed photonuclear assessment detection technologies. Specifically, there is a need for methods of providing adequate material stimulation in pulsed photonuclear assessment detection technologies while decreasing interference between the interrogation radiation and the induced delayed signatures emitted from a stimulated nuclear material.

### BRIEF SUMMARY OF THE INVENTION

An embodiment of the present invention comprises a method of operating a photonuclear detection system. The method includes transmitting photons toward a container for a duration of a first time period and waiting for a duration of a second time period. The duration of the second time period may be substantially equal to a detector recovery time of a radiation detector configured to detect induced delayed signatures. The method further includes measuring for induced delayed signatures for a duration of a third time period.

Another embodiment of the present invention includes a method of operating a photonuclear detection system. The method includes irradiating a container with a beam of photons for a time duration. The time duration is at least partially dependent on a half-life characteristic of fission fragments that would be produced upon stimulation of a nuclear material to be detected for in the container. The method also includes waiting for another time duration at least partially dependent on a known detector recovery time of a radiation detector adjacent the container. The method further includes detecting material signatures emitted from the container for an additional time duration. The additional time duration is at least partially dependent on the half-life characteristic of the fission fragments.

Another embodiment of the present invention includes a method of operating a photonuclear detection system including a linear accelerator, a radiation detector, and a container. The method includes varying a measurement cycle time duration of the photonuclear detection system depending on a detector recovery time of the radiation detector and a half-life characteristic of fission fragments that would be produced upon stimulation of a nuclear material that may exist within the container.

Yet another embodiment of the present invention includes a computer-readable media storage medium storing instructions that, when executed by a processor, cause the processor to perform instructions for operating a photonuclear detection system according to an embodiment of the present invention.

### BRIEF DESCRIPTION OF THE DRAWINGS

FIG. 1 illustrates a conventional photonuclear detection system including an interrogation source, a radiation detector, and a container which may include a nuclear material to be detected;

FIG. 2 illustrates a representative timing diagram of an operation of a photonuclear detection system, according to an embodiment of the present invention; and

FIG. 3 is a flow chart illustrating a method of operating a photonuclear detection system, in accordance with an embodiment of the present invention.

### DETAILED DESCRIPTION OF THE INVENTION

In the following detailed description, reference is made to the accompanying drawings which form a part hereof and, in which is shown by way of illustration, specific embodiments in which the invention may be practiced. These embodiments are described in sufficient detail to enable those of ordinary skill in the art to practice the invention, and it is to be understood that other embodiments may be utilized, and that structural, logical, and electrical changes may be made within the scope of the disclosure.

In this description, functions may be shown in block diagram form in order not to obscure the present invention in unnecessary detail. Furthermore, specific implementations shown and described are only examples and should not be construed as the only way to implement the present invention unless specified otherwise herein. Block definitions and partitioning of logic between various blocks represent a specific, non-limiting implementation. It will be readily apparent to one of ordinary skill in the art that the various embodiments of the present invention may be practiced by numerous other partitioning solutions. For the most part, details concerning timing considerations, and the like, have been omitted where such details are not necessary to obtain a complete understanding of the present invention in its various embodiments and are within the abilities of persons of ordinary skill in the relevant art.

When executed as firmware or software, the instructions for performing the methods and processes described herein may be stored on a computer readable medium. A computer readable medium includes, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory.

Referring in general to the following description and accompanying drawings, various aspects of the present invention are illustrated to show its structure and method of operation. Common elements of the illustrated embodiments are designated with like numerals. It should be understood that the figures presented are not meant to be illustrative of actual views of any particular portion of the actual structure or method, but are merely idealized representations which are employed to more clearly and fully depict the present invention.

As described more fully below, various embodiments of the present invention relate to methods of operating a photonuclear detection system. A method of operating a photonuclear detection system may include irradiating a container with a beam of photons from an interrogation source for duration of a first time period, turning off the interrogation source and waiting for a duration of a second time period, and measuring for induced delayed signatures (i.e., delayed neutrons and/or delayed gamma-rays) with a radiation detector for a duration of a third time period. The durations of each of the first, second, and third time periods may be dependent on a variable of the photonuclear detection system, a characteristic of a nuclear material to be detected, and/or the repetition rate of the linac.

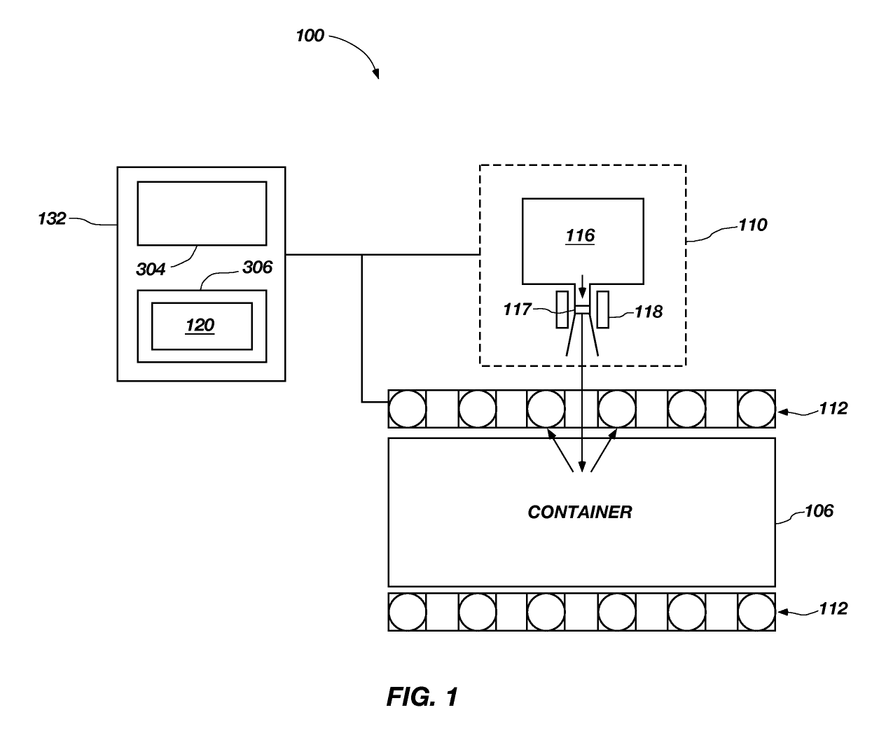

For explanatory purposes only, a conventional photonuclear detection system will first be described. Thereafter, various contemplated methods of operating a photonuclear detection system in accordance with one or more embodiments of the present invention will be discussed. FIG. 1 illustrates a photonuclear detection system 100 used to detect the presence of a nuclear material, such as, for example only, highly enriched uranium (HEU), depleted uranium, plutonium, or thorium. Photonuclear detection system 100 may also be commonly referred to hereinafter as an “interrogation system.” Photonuclear detection system 100 includes an object 106, an interrogation source 110, a detector 112, and a computer 132. For ease of description, object 106 may be referred to herein as “container 106.” Computer 132 may include a processor 304 and a memory 306. Memory 306 may include computer readable medium (e.g., data storage device 120), which may include, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory. As illustrated in FIG. 1, computer 132 may be operably coupled to interrogation source 110 and radiation detector 112.

Container 106 is, or contains, the material to which a determination is being made regarding its nuclear material contents. Container 106 may be any container capable of transporting or smuggling nuclear materials. For example, container 106 may be a truck, a drum, or a shipping container such as those used by cargo container ships. As commonly known in the art, nuclear materials may be characterized by a “half-life.” A material's half-life is a time duration required for a quantity of the material to be reduced to one-half of its original value. Furthermore, as described more fully below, as a particular nuclear material is stimulated by a beam of high-energy photons, associated fission fragments, which also exhibit a half-life, may be produced.

As will be appreciated by a person having ordinary skill in the art, interrogation source 110 may comprise a linear accelerator 116, an electron to photon converter 117, and a collimator 118. Linear accelerator 116 may be configured to generate a beam of electrons that are converted to high-energy photons by way of converter 117, collimated to a pre-selected diameter by collimator 118, and forward directed toward container 106. The photons are commonly referred to in the art as “bremsstrahlung photons.” The process of generating a voluminous number of photons using a single pulse of electrons generated from a pulsed, linear accelerator may be commonly referred to in the art as a “photon flash event.” Common LINACs can produce these flash events at rates of hundreds of times per second.

The generated photons have the ability to pass through many different shielding configurations. For example, the energy of interrogating source 110 may be selected in order to provide photons with energy spectra appropriate for optimal penetration of a given shield. Thus, the photons are able to pass through the walls of container 106, as well as most shielding that may be used to conceal or smuggle nuclear materials in a given container. The photons react with container 106 itself and materials within the container to induce photonuclear reactions (i.e., generate fission fragments) with container 106 and its contents causing neutrons to be emitted from container 106.

Radiation detector 112 may be located in the proximity of the container 106, and may comprise, for example, an array of radiation detectors. As non-limiting examples, radiation detector 112 may comprise a bare helium-3 neutron detector or a high-purity germanium (HPGe) detector. Photo-induced delayed neutrons emitted from container 106 may be detected by radiation detector 112 and analyzed by electronics and other devices, such as computer 132 or any other computers (not shown) associated with radiation detector 112. As known by a person having ordinary skill in the art, a radiation detector (i.e., radiation detector 112) may exhibit a “detector recovery time.” A radiation detector's detector recovery time may be defined as a time period required for the radiation detector to recover from a photon flash event in order to measure a meaningful signal (e.g., a signal having a signal-to-noise ratio of at least 1.1). The detector recovery time may be dependent on various characteristics of a photonuclear detection system, such as the type of radiation detector and the type of linear accelerator used in the photonuclear detection system. As will be appreciated by a person of ordinary skill in the art, the recovery time of a radiation detector within a photonuclear detection system may be determined through experimental testing of the radiation detector and the associated linear accelerator. It should be noted that although embodiments of the present invention are described with reference to photonuclear detection system 100, it will be appreciated by a person having ordinary skill in the art that embodiments of the present invention may be implemented with any known like active detection system.

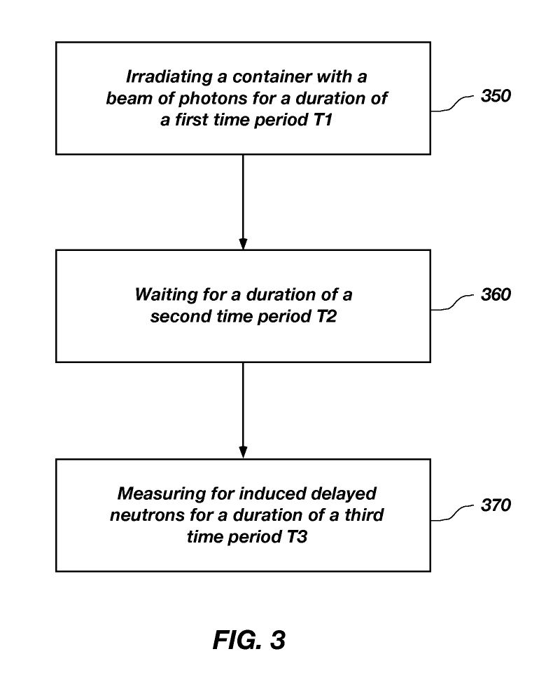

With reference to FIGS. 1-3, and in accordance with one or more embodiments of the present invention, various contemplated methods of operating a photonuclear detection system will now be discussed. A method of operating photonuclear detection system 100 may include turning “on” linear accelerator 116 and irradiating container 106 with a beam of photons for a duration of a first time period T1 (depicted by numeral 350 in FIG. 3), turning “off” linear accelerator 116 and waiting for a duration of a second time period T2 (depicted by numeral 360 in FIG. 3), and turning “on” radiation detector 112 and measuring for induced delayed neutrons with radiation detector 112 for a duration of a third time period T3 (depicted by numeral 370 in FIG. 3).

A cycle of completing the three time periods (i.e., first time period T1, second time period T2, and third time period T3) may be referred to hereinafter as a “measurement cycle” of photonuclear detection system 100. Furthermore, a time duration to complete one measurement cycle (i.e., the sum of the first time period t1, second time period t2, and third time period t3) may be referred to hereinafter as a “measurement cycle time duration” of photonuclear detection system 110. Moreover, for a given total experiment time Tₜₒₜₐₗ during which container 106 is interrogated, a measurement cycle of photonuclear detection system 100 may be repeated for a number of intervals N, which may be defined as:

N=Tₜₒₜₐₗ/(T1+T2+T3); (1)

wherein Tₜₒₜₐₗ is total experiment time during which container 106 is interrogated, T1 is the duration of the first time period, T2 is the duration of the second time period, and T3 is the duration of the third time period.

“Rules of thumb” for determining the durations of time period T1, time period T2, and time period T3 will now be discussed. As described above, a “detector recovery time” (i.e., recovery time) is a time period wherein the interrogation radiation (i.e., photons generated by linear accelerator 116) and any induced delayed neutrons (i.e., material signatures) begin to die-away. The detector recovery time may enable radiation detector 112 to recover from the interrogation environment so it may measure a meaningful signal. In accordance with an embodiment of the present invention, a duration of time period T2 may be set substantially equal to the detector recovery time of radiation detector 112. As a non-limiting example, if a recovery of time of radiation detector 112 is 0.25 seconds, then a duration of time period T2 may be set substantially equal to 0.25 seconds.

As mentioned above, during first time period T1, container 106 is irradiated with a beam of photons generated by linear accelerator 116. The beam of photons may react with container 106 and, in the event a nuclear material is present, may generate fission fragments which may emit delayed neutrons from container 106. A duration of time period Ti may be at least partially dependent on a half-life of the fission fragments that would be produced from the stimulation of any nuclear material that may exist within container 106. More specifically, a duration of time period T1 may be defined by the following equation:

T1=[t_{1/2}−T2]/2; (2)

wherein T2 is the duration of the second time period (i.e., detector recovery time) and t_{1/2} is the half-life of the fission fragments that would be produced from the stimulation of any nuclear material that may be present within container 106.

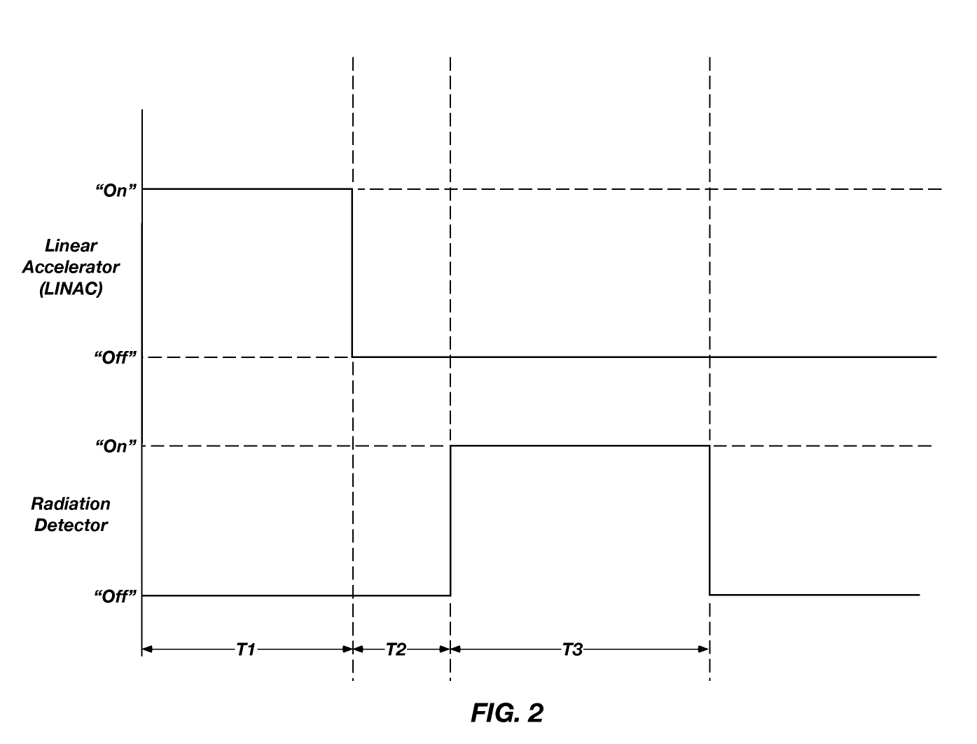

As illustrated in FIG. 2, after completion of time period T2, radiation detector 112 may be activated for a duration of time period T3 to measure any induced delayed neutrons that may exist. A duration of time period T3 may be at least partially dependent on a half-life of the fission fragments that would be produced from the stimulation of any nuclear material that may exist within container 106. More specifically, a duration of time period T3 may be defined by the following equation:

T3=[t_{1/2}−T2]/2; (3)

wherein T2 is duration of the second time period and t_{1/2} is the half-life of the fission fragments that would be produced from the stimulation of any nuclear material that may be present within container 106.

For example, using equations (1), (2), and (3), in a case wherein the fission fragments that may be produced exhibit a half-life of two seconds, and a detector recovery time of radiation detector 112 is equal to 0.25 seconds, the duration of time period T1 would be equal to 0.875 seconds (T1=[2−0.25]/2=0.875), the duration of time period T3 would be equal to 0.875 seconds (T3=[2−0.25]/2=0.875), and the measurement cycle time duration would be equal to two seconds (0.875 seconds+0.25 seconds+0.875 seconds=2.0 seconds). Furthermore, assuming that the total experiment time Tₜₒₜₐₗ is equal to 180 seconds, ninety measurement cycle intervals N would occur during the time in which container 106 is interrogated (180 seconds=90*2 seconds).

As such, in accordance with one or more embodiments of the present invention the following “rules of thumb” may apply to a method of operating an photonuclear detection system:

T1=T3; (4)

T1+T2+T3=t _{1/2}; (5)

and

T2=detector recovery time; (6)

wherein T1 is the duration of the first time period, T2 is the duration of the second time period, T3 is the duration of the third time period, and t_{1/2} is the half-life of the fission fragments that would be produced from the stimulation of any nuclear material that may be present within container 106.

It should be noted that that equations (2), (3) and (5) above may apply in cases wherein the total experiment time Tₜₒₜₐₗ is greater than the half-life t_{1/2} of the fission fragments (Tₜₒₜₐₗ>t_{1/2}) that would be produced from the stimulation of any nuclear material that may exist within container 106. In other cases, wherein the total experiment time Tₜₒₜₐₗ is substantially equal to or less than the half-life t_{1/2} of the fission fragments (Tₜₒₜₐₗ˜t_{1/2} or T<t_{1/2}) that would be produced upon stimulation of any existent nuclear material, the number of measurement cycle intervals N may be set equal to one (N=1), and the total experiment time Tₜₒₜₐₗ may be limited to a maximum amount of time, such as, for example only, 180 seconds (Tₜₒₜₐₗ=180 seconds). The durations of time periods T1, T2, and T3 may then be solved using equations (1), (4), and (6). For example, wherein the fission fragments exhibit a half-life of one year, and a detector recovery time is equal to 0.25 seconds (i.e., T2=0.25 seconds), the total experiment time Tₜₒₜₐₗ may be set equal to 180 seconds (Tₜₒₜₐₗ=180 seconds), the number of measurement cycle intervals N may be set equal to one (N=1) and, therefore, the duration of time period T1 and the duration of time period T3 would each be equal to 89.875 seconds.

Furthermore, in accordance with another embodiment of the present invention, a duration of time period T2 may be additionally adjusted to further optimize photonuclear detection system 100. More specifically, in a case wherein the fission fragments that would be produced upon stimulation of a nuclear material have a long half-life (e.g., 75 seconds or longer), a duration of time period T2 may be increased. For example only, a duration of time period T2 may be increased up to four times the recovery time of radiation detector 112. Accordingly, if the recovery time of radiation detector 112 is equal to 0.25 seconds and the half-life of a material to be detected is, for example, 75 seconds or longer, the duration of time period T2 may be increased from 0.25 seconds to approximately one second.

While the present invention has been described herein with respect to certain preferred embodiments, those of ordinary skill in the art will recognize and appreciate that it is not so limited. Rather, many additions, deletions, and modifications to the preferred embodiments may be made without departing from the scope of the invention as hereinafter claimed. In addition, features from one embodiment may be combined with features of another embodiment while still being encompassed within the scope of the invention as contemplated by the inventors.

What is claimed is:

1. A method of operating a photonuclear detection system, comprising:
transmitting photons toward a container for a duration of a first time period;
waiting for a duration of a second time period substantially equal to a detector recovery time of a radiation detector configured to detect induced delayed signatures; and
measuring for induced delayed signatures for a duration of a third time period.

2. The method of claim 1, wherein transmitting photons toward a container for a duration of a first time period comprises transmitting photons toward a container for a duration of a first time period determined using the equation:
T1=[t_{1/2}−T2]/2
wherein T1 is the duration of the first time period, T2 is the duration of the second time period, and t_{1/2} is the half-life of a fission fragments that would be produced upon stimulation of a nuclear material that may exist within the container.

3. The method of claim 1, wherein measuring for induced delayed signatures for a duration of a third time period comprises measuring for induced delayed signatures for a duration of a third time period determined using the equation:
T3=[t_{1/2}−T2]/2
wherein T3 is the duration of the third time period, T2 is the duration of the second time period, and t_{1/2} is the half-life of a fission fragments that would be produced upon stimulation of a nuclear material that may exist within the container.

4. The method of claim 1, wherein transmitting photons toward a container for a duration of a first time period comprises transmitting photons toward a container for a duration of a first time period at least partially dependent on a half-life characteristic of fission fragments that would be produced upon stimulation of a nuclear material that may exist within the container.

5. The method of claim 1, wherein measuring for induced delayed signatures for a duration of a third time period comprises measuring for induced delayed signatures for a duration of a third time period at least partially dependent on a half-life characteristic of fission fragments that would be produced upon stimulation of a nuclear material that may exist within the container.

6. The method of claim 1, wherein measuring for induced delayed signatures for a duration of a third time period comprises measuring for induced delayed signatures for a duration of a third time period substantially equal to the duration of the first time period.

7. The method of claim 1, further comprising determining the detector recovery time of the radiation detector.

8. The method of claim 1, further comprising turning off a linear accelerator configured to transmit the photons toward the container after transmitting the photons for the duration of the first time period.

9. The method of claim 1, wherein a sum of the durations of the first time period, the second time period, and the third time period is substantially equal to the half-life characteristic of fission fragments that would be produced upon stimulation of a nuclear material that may exist within the container.

10. A method of operating a photonuclear detection system, comprising:
irradiating a container with a beam of photons for a time duration at least partially dependent on a half-life characteristic of fission fragments that would be produced upon stimulation of a nuclear material to be detected for in the container;
waiting for another time duration at least partially dependent on a known detector recovery time of a radiation detector proximate the container; and
detecting material signatures emitted from the container for an additional time duration at least partially dependent on the half-life characteristic of the fission fragments.

11. The method of claim 10, wherein waiting for another time duration comprises waiting for another time duration at least partially dependent on the half-life characteristic of fission fragments.

12. The method of claim 10, wherein waiting for another time duration comprises waiting for another time duration substantially equal to the known detector recovery time of the radiation detector.

13. The method of claim 10, wherein waiting for another time duration comprises waiting for another time duration greater than or equal to the known detector recovery time of the radiation detector.

14. The method of claim 10, wherein irradiating a container with a beam of photons for a time duration comprises irradiating a container with a beam of photons generated from a linear accelerator for the time duration.

15. The method of claim 10, wherein detecting material signatures emitted from the container for an additional time duration comprises detecting material signatures emitted from the container with the radiation detector for the additional time duration.

16. The method of claim 10, wherein detecting material signatures emitted from the container for an additional time duration comprises detecting material signatures emitted from the container for an additional time duration at least partially dependent on the known detector recovery time of the radiation detector.

17. The method of claim 10, wherein irradiating a container with a beam of photons for a time duration comprises irradiating a container with a beam of photons for a time duration at least partially dependent on the known detector recovery time of the radiation detector.

18. A computer-readable media storage medium storing instructions that when executed by a processor cause the processor to perform instructions for operating a photonuclear detection system, the instructions comprising:
irradiating a container with a photon beam for a duration of a first time period;
waiting for a duration of a second time duration substantially equal to or greater than a detector recovery time of a radiation detector adjacent the container; and
measuring for induced material signatures emitted from the container for a duration of a third time period.

19. A method of operating a photonuclear detection system including a linear accelerator, a radiation detector, and a container, the method comprising varying a measurement cycle time duration of the photonuclear detection system depending on a detector recovery time of the radiation detector and a half-life characteristic of fission fragments that would be produced upon stimulation of a nuclear material that may exist within the container.

20. The method of claim 19, wherein varying a measurement cycle time duration comprises setting the measurement cycle time duration substantially equal to the half-life characteristic of the fission fragments.
